(19) United States
(12) Patent Application Publication
(10) Pub. No.: US 2019/0119460 A1
(43) Pub. Date: Apr. 25, 2019

(54) POLYURETHANES HAVING A REDUCED ALDEHYDE EMISSION

(71) Applicant: BASF SE, Ludwigshafen am Rhein (DE)

(72) Inventors: Zeljko Tomovic, Lemfoerde (DE); Iran Otero Martinez, Lemfoerde (DE)

(21) Appl. No.: 16/306,060

(22) PCT Filed: Jun. 1, 2017
(86) PCT No.: PCT/EP2017/063297

§ 371 Date: Nov. 30, 2018

(30) Foreign Application Priority Data
Jun. 3, 2016 (EP) 16172951.2

(51) Int. Cl. C08J 9/00; C08G 18/48; C08G 18/42; C08G 18/40; C08G 18/76; C08G 18/12; C08G 18/18; C08K 5/25; C08J 9/04

(52) U.S. Cl. CPC C08J 9/0028; C08G 18/4837; C08G 18/4216; C08G 18/4018; C08G 2101/00; C08G 18/12; C08G 18/1825; C08K 5/25; C08J 9/04; C08G 18/7664

(57) ABSTRACT

Described herein is a process for producing a polyurethane where (a) polyisocyanate, (b) polymeric compounds having groups reactive toward isocyanates, (c) catalysts, (d) compounds of a general formula R(—S)ₙ, where R is any desired moiety, n is any desired number from 1 to 8, and S is a moiety of formula 1:

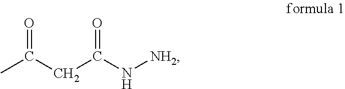

and optionally (e) blowing agents, (f) chain extenders and/or crosslinking agents, and (g) auxiliaries and/or additional substances are mixed to give a reaction mixture, and the reaction mixture is reacted to completion to give the polyurethane.

### FIELD OF INVENTION

The present invention relates to a process for the production of polyurethanes where (a) polyisocyanate, (b) polymeric compounds having groups reactive toward isocyanates, (c) catalysts, (d) compounds of the general formula R(—S)ₙ, where R is any desired moiety, n is any desired number from 1 to 8, and S is a moiety of formula 1:

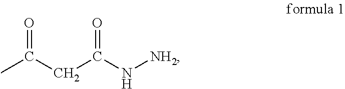

and optionally (e) blowing agents, (f) chain extenders and/or crosslinking agents, and (g) auxiliaries and/or additional substances are mixed to give a reaction mixture, and the reaction mixture is reacted to completion to give the polyurethane. The present invention further relates to a polyurethane which can be produced by said process, and also to the use of said polyurethane in enclosed spaces, for example in means of conveyance.

### BACKGROUND

Polyurethanes are versatile, being used by way of example as seat cushioning in the furniture industry and as binders for particleboard, as insulation material in the construction industry, as insulation material by way of example for pipes, hot-water tanks and refrigerators, and as cladding components, for example in vehicle construction. In particular, polyurethanes are frequently used in automobile construction, for example in the external cladding of automobiles as spoilers, roof elements, and spring elements, and also in the interior cladding of automobiles as roof cladding, carpet-backing foam, door cladding, steering wheels, control knobs, and seat cushioning.

In this context it is known that polyurethanes tend to emit organic substances which can cause unpleasant odors or in the event of high concentrations, can cause health-related problems. Enclosed spaces are in particular affected here, for example in the interiors of buildings or vehicles, for example automobiles. An example of these emissions is emission of aldehydes. Various attempts have already been made to reduce these aldehyde emissions.

By way of example EP 1428847 says that aldehyde emissions can be reduced by subsequent addition of polymeric substances having primary and/or secondary amino groups. The amine groups in the polymer are responsible for the reduction of emissions. Because these are reactive toward isocyanate and are very substantially deactivated via reaction with the isocyanate, the active polymeric ingredient should be added after production of the foam. This disadvantageously involves an inconvenient process with an additional step of post-treatment of the foam. It cannot be used in compact systems or in closed-cell foams.

US 20130203880 describes the use of polyhydrazodicarbonamide as substance for reducing aldehyde emissions in polyurethane foams. However, significant aldehyde reduction is achieved only by adding a large quantity of polyhydrazodicarbonamide in the polyol component: from 2 to 5.5% by weight. Because polyhydrazodicarbonamide also has catalytic properties, addition of that substance in quantities of that magnitude alters the reaction profile. The aldehyde reduction achieved is moreover not entirely satisfactory, even when large quantities of polyhydrazodicarbonamide are used.

US 2006/0141236 describes the use of hydrazine compounds in polyurethanes as aldehyde scavengers. Here, the active substance is added directly to the polyol component. The examples describe the use of acetic hydrazide, carbonic hydrazide and adipic dihydrazide. Aldehyde emission reductions of from 60 to 70% are thus obtained

WO 2015082316 describes the use of CH-acidic compounds of the general formula R¹—CH₂—R², where R¹ and R² are mutually independently an electron-withdrawing moiety, for formaldehyde emission reduction in combination with incorporable catalysts. Effective formaldehyde reduction can be achieved here, but the foam samples always exhibit high emissions of volatile organic substances (VOC).

### DESCRIPTION

It was an object of the present invention to provide polyurethanes, in particular polyurethane foams, which have reduced aldehyde emission, particularly of formaldehyde and acetaldehyde. In particular the substances responsible for the aldehyde emission reduction should exhibit long lasting effectiveness and should not lead to any additional emissions from the polyurethane. A further intention is that the low-emission polyurethane foams be amenable to production by a simple process where the substances responsible for the aldehyde emission reduction can be added directly to the reaction mixture for the production of the polyurethane. In particular, the intention here is to use substances which are inexpensive and easy to handle, and which have no adverse effect on the production of polyurethanes.

Surprisingly, the object of the invention has been achieved via a process for the production of polyurethanes where (a) polyisocyanate, (b) polymeric compounds having groups reactive toward isocyanates, (c) catalysts, (d) compounds of the general formula R(—S)ₙ, where R is any desired moiety, n is any desired number from 1 to 8, and S is a moiety of formula 1:

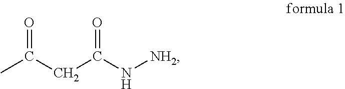

and optionally (e) blowing agents, (f) chain extenders and/or crosslinking agents, and (g) auxiliaries and/or additional substances are mixed to give a reaction mixture, and the reaction mixture is reacted to completion to give the polyurethane. The present invention further relates to a polyurethane which can be produced by said process, and also to the use of the polyurethane of the invention in enclosed spaces, for example in means of conveyance.

For the purposes of the invention, polyurethane comprises all known polyisocyanate polyaddition products. These comprise addition products made from isocyanate and alcohol, and also modified polyurethanes which can comprise isocyanurate structures, allophanate, structures, urea structures, carbodiimide structures, uretonimine structures, biuret structures, and other isocyanate addition products. These polyurethanes of the invention in particular comprise compact polyisocyanate polyaddition products, for example thermosets, and foams based on polyisocyanate polyaddition products, for example flexible foams, semirigid foams, rigid foams and integral foams, and also polyurethane coatings and binders. For the purposes of the invention, the term polyurethanes also covers polymer blends comprising polyurethanes and other polymers, and also foams made from these polymer blends. The polyurethanes of the invention are preferably polyurethane foams or compact polyurethanes which comprise no polymers other than those in the polyurethane constituents (a) to (g) explained hereinafter.

For the purposes of the invention, the expression polyurethane foams means foams in accordance with DIN 7726. The compressive stress at 10% compression or, respectively, compressive strength in accordance with DIN 53 421/DIN EN ISO 604 of flexible polyurethane foams of the invention here is 15 kPa or less, preferably from 1 to 14 kPa and in particular from 4 to 14 kPa. The compressive stress at 10% compression of semirigid polyurethane foams of the invention in accordance with DIN 53 421/DIN EN ISO 604 is from more than 15 to less than 80 kPa. The open-cell factor of semirigid polyurethane foams and flexible polyurethane foams of the invention in accordance with DIN ISO 4590 is preferably more than 85%, particularly preferably more than 90%. Further details concerning flexible polyurethane foams and semirigid polyurethane foams of the invention are found in “Kunststoffhandbuch [Plastics handbook], volume 7, Polyurethane [polyurethanes]”, Carl Hanser Verlag, 3rd edition 1993, chapter 5.

The compressive stress at 10% compression of rigid polyurethane foams of the invention is greater than or equal to 80 kPa, preferably greater than or equal to 120 kPa, particularly preferably greater than or equal to 150 kPa. The closed-cell factor of the rigid polyurethane foam in accordance with DIN ISO 4590 is moreover more than 80%, preferably more than 90%. Further details concerning rigid polyurethane foams of the invention are found in “Kunststoffhandbuch [Plastics handbook], volume 7, Polyurethane [polyurethanes]”, Carl Hanser Verlag, 3rd edition 1993, chapter 6.

For the purposes of this invention, the expression elastomeric polyurethane foams means polyurethane foams in accordance with DIN 7726 which exhibit no residual deformation above 2% of their initial thickness 10 minutes after brief deformation by 50% of their thickness in accordance with DIN 53 577. The material here can be a rigid polyurethane foam, a semirigid polyurethane foam or a flexible polyurethane foam.

Integral polyurethane foams are polyurethane foams in accordance with DIN 7726 with a peripheral zone that, as a result of the shaping process, has higher density than the core. The overall envelope density averaged across the core and the peripheral zone here is preferably above 100 g/L. Again, integral polyurethane foams for the purposes of the invention can be rigid polyurethane foams, semirigid polyurethane foams or flexible polyurethane foams. Further details concerning integral polyurethane foams of the invention are found in “Kunststoffhandbuch [Plastics handbook], volume 7, Polyurethane [Polyurethanes]”, Carl Hanser Verlag, 3rd edition 1993, chapter 7.

Polyurethane foams of the invention are obtained here in that polyisocyanates (a) are mixed with polymeric compounds (b) having groups reactive toward isocyanates, catalysts (c), compounds (d) of the general formula R(—S)ₙ, where R is any desired moiety, n is any desired number from 1 to 8, and S is a moiety of formula 1:

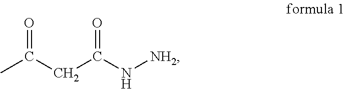

and optionally blowing agent (e), chain extender (f) and other auxiliaries and additional substances (g) to give a reaction mixture, and reacting the above to completion.

In a preferred embodiment here, the polyurethane of the invention is a polyurethane foam with average density from 10 to 850 g/L, preferably a semirigid polyurethane foam or a flexible polyurethane foam or a rigid polyurethane foam, particularly preferably an elastomeric flexible polyurethane foam, a semirigid polyurethane foam, or an elastomeric integral polyurethane foam. The density of the elastomeric integral polyurethane foam averaged across the core and the peripheral zone is preferably from 150 to 500 g/L. The average density of the flexible polyurethane foam is preferably 10 to 100 g/L. The average density of the semirigid polyurethane foam is preferably from 70 to 150 g/L.

In another preferred embodiment, the polyurethane is a compact polyurethane with density preferably more than 850 g/L, preferably from 900 to 1400 g/L and particularly preferably from 1000 to 1300 g/L. A compact polyurethane is obtained here without addition of a blowing agent. For the purposes of the present invention, small quantities of blowing agent, for example water, comprised in the polyols as a result of the production process are not interpreted as implying addition of blowing agent. The reaction mixture for the production of the compact polyurethane preferably comprises less than 0.2% by weight of water, particularly preferably less than 0.1% by weight and in particular less than 0.05% by weight.

The polyurethane of the invention is preferably used here in the space within means of transport, examples being ships, aircraft, trucks, cars and buses, particularly preferably cars and buses, and in particular cars. The space within cars and buses here is hereinafter termed automobile interior. A flexible polyurethane foam can be used here as seat cushion; a semirigid polyurethane foam can be used here as foam backing of door side elements or instrument panels; an integral polyurethane foam can be used here as steering wheel, control knob or headrest, and a compact polyurethane can be used here by way of example as cable sheathing.

The polyisocyanate components (a) used for the production of the polyurethanes of the invention comprise any of the polyisocyanates known for the production of polyurethanes. These comprise the aliphatic, cycloaliphatic, and aromatic difunctional or polyfunctional isocyanates known from the prior art, and also any desired mixtures thereof. Examples are diphenylmethane 2,2′-, 2,4′-, and 4,4′-diisocyanate, the mixtures of monomeric diphenylmethane diisocyanates with diphenylmethane diisocyanate homologs having a larger number of rings (polymer MDI), isophorone diisocyanate (IPDI) and its oligomers, tolylene 2,4- and 2,6-diisocyanate (TDI), and mixtures of these, tetramethylene diisocyanate and its oligomers, hexamethylene diisocyanate (HDI) and its oligomers, naphthylene diisocyanate (NDI), and mixtures thereof.

It is preferable to use tolylene 2,4- and/or 2,6-diisocynate (TDI) or a mixture thereof, monomeric diphenylmethane diisocyanates, and/or diphenylmethane diisocyanate homologs having a larger number of rings (polymer MDI), and mixtures of these. Other possible isocyanates are mentioned by way of example in “Kunststoffhandbuch [Plastics handbook], volume 7, Polyurethane [Polyurethanes]”, Carl Hanser Verlag, 3^{rd} edition 1993, chapters 3.2 and 3.3.2.

Polyisocyanate component (a) used can take the form of polyisocyanate prepolymers. These polyisocyanate prepolymers are obtainable by reacting the polyisocyanates described above (constituent (a-1)) in excess, for example at temperatures of from 30 to 100° C., preferably at about 80° C., with polymeric compounds (b) (constituent (a-2)), having groups reactive toward isocyanates, and/or with chain extenders (c) (constituent (a-3)) to give the isocyanate prepolymer.

Polymeric compounds (a-2) having groups reactive toward isocyanates, and chain extenders (a-3), are known to the person skilled in the art and are described by way of example in “Kunststoffhandbuch [Plastics handbook], volume 7, Polyurethane [Polyurethanes]”, Carl Hanser Verlag, 3^{rd} edition 1993, chapter 3.1: by way of example, it is also possible to use, as polymeric compounds (a-2) having groups reactive toward isocyanates, the polymeric compounds described under (b) having groups reactive toward isocyanates.

It is possible to use, as polymeric compounds (b) having groups reactive toward isocyanates, any of the known compounds having at least two hydrogen atoms reactive toward isocyanates, for example those with functionality from 2 to 8 and with number-average molar mass from 400 to 15 000 g/mol: by way of example it is possible to use compounds selected from the group of the polyether polyols, polyester polyols, and mixtures thereof.

Polyetherols are by way of example produced from epoxides, for example propylene oxide and/or ethylene oxide, or from tetrahydrofuran with starter compounds exhibiting hydrogen-acivity, for example aliphatic alcohols, phenols, amines, carboxylic acids, water, or compounds based on natural substances, for example sucrose, sorbitol or mannitol, with use of a catalyst. Mention may be made here of basic catalysts and double-metal cyanide catalysts, as described by way of example in PCT/EP2005/010124, EP 90444, or WO 05/090440.

Polyesterols are by way of example produced from aliphatic or aromatic dicarboxylic acids and polyhydric alcohols, polythioether polyols, polyesteramides, hydroxylated polyacetals, and/or hydroxylated aliphatic polycarbonates, preferably in the presence of an esterification catalyst. Other possible polyols are mentioned by way of example in “Kunststoffhandbuch [Plastics handbook], volume 7, Polyurethane [Polyurethanes]”, Carl Hanser Verlag, 3^{rd} edition 1993, chapter 3.1.

Other materials that can be used, alongside the polyetherols and polyesterols described, are polyetherols or polyesterols which are also termed polymer polyetherols or polymer polyesterols and which comprise fillers. These compounds preferably comprise dispersed particles made of thermoplastics, for example composed of olefinic monomers such as acrylonitrile, styrene, (meth)acrylates, (meth)acrylic acid, and/or acrylamide. These polyols comprising fillers are known and are obtainable commercially. A production process for these is described by way of example in DE 111 394, U.S. Pat. Nos. 3,304,273, 3,383,351, 3,523,093 DE 1 152 536, DE 1 152 537, WO 2008/055952, and WO 2009/128279.

In a particularly preferred embodiment of the present invention, component (b) comprises polyetherols, and more preferably comprises no polyesterols.

Catalysts c) greatly accelerate the reaction of the polyols (b) and optionally chain extenders and crosslinking agents (f), and also of chemical blowing agent (e), with the organic, optionally modified polyisocyanates (a). The catalysts (c) here preferably comprise incorporable amine catalysts.

The following may be mentioned by way of example as conventional catalysts that can be used for the production of polyurethanes: amidines, such as 2,3-dimethyl-3,4,5,6-tetrahydropyrimidine, tertiary amines, such as triethylamine, tributylamine, dimethylbenzylamine, N-methyl-, N-ethyl-, and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine, and dimethylethanolamine. It is also possible to use organometallic compounds, preferably organotin compounds, such as tin(II) salts of organic carboxylic acids, e.g. tin(II) acetate, tin(II) octanoate, tin(II) ethylhexanoate, and tin(II) laurate, and the dialkyltin(IV) salts of organic carboxylic acids, e.g. dibutyltin diacetate, dibutyltin dilaurate, dibutyltin maleate, and dioctyltin diacetate, and also bismuth carboxylates, such as bismuth(III) neodecanoate, bismuth 2-ethylhexanoate, and bismuth octanoate, or a mixture thereof. The organometallic compounds can be used alone or preferably in combination with strongly basic amines. If component (b) involves an ester, it is preferable to use exclusively amine catalysts.

Incorporable amine catalysts have at least one, preferably from 1 to 8, and particularly preferably from 1 to 2, group(s) reactive toward isocyanates, examples being primary amine groups, secondary amine groups, hydroxy groups, amides or urea groups, preferably primary amine groups, secondary amine groups, hydroxy groups. Incorporable amine catalysts are mostly used for the production of low-emission polyurethanes which in particular are used in the automobile interior sector. These catalysts are known and are described by way of example in EP1888664. These comprise compounds which preferably comprise, alongside the group(s) reactive toward isocyanates, one or more tertiary amino groups. It is preferable that at least one of the tertiary amino groups of the incorporable catalysts bears at least two aliphatic hydrocarbon moieties, preferably having from 1 to 10 carbon atoms per moiety, particularly preferably having from 1 to 6 carbon atoms per moiety. It is particularly preferable that the tertiary amino groups bear two moieties selected mutually independently from methyl and ethyl moiety, and also bear another organic moiety. Examples of incorporable catalysts that can be used are bisdimethylaminopropylurea, bis(N,N-dimethylaminoethoxyethyl) carbamate, dimethylaminopropylurea, N,N,N-trimethyl-N-hydroxyethylbis(aminopropyl ether), N,N,N-trimethyl-N-hydroxyethylbis(aminoethyl ether), diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol), (1,3-bis(dimethylamino)propan-2-ol), N,N-bis(3-dimethylaminopropyl)-N-isopropanolamine, bis(dimethylaminopropyl)-2-hydroxyethylamine, N,N,N-trimethyl-N-(3-aminopropyl)bis(aminoethyl ether), 1,4-diazabicyclo[2.2.2]octane-2-methanol and 3-dimethylaminoisopropyldiisopropanolamine, and mixtures thereof.

Catalysts (c) can by way of example be used at a concentration of from 0.001 to 5% by weight, in particular from 0.05 to 2% by weight in the form of catalyst or of catalyst combination, based on the weight of component (b). In a particularly preferred embodiment, catalysts (c) used are exclusively incorporable catalysts.

A compound of the general formula R(—S)ₙ, is used as component (d), where R is any desired moiety, n is any desired number from 1 to 8, and S is a moiety of formula 1:

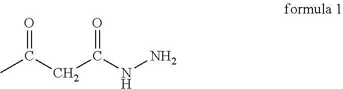

It is preferable that the moiety R comprises hydrogen atoms and carbon, nitrogen and/or oxygen atoms. R can by way of example be a hydrocarbon moiety, a polyether moiety or a polyester moiety, for example a polyether moiety or polyester moiety which corresponds to one of the polymeric compounds (b) having groups reactive toward isocyanate, where one or more of the terminal hydrogen atoms has been replaced by a moiety of the general formula (1). When n=1, R is by way of example a moiety selected from the group consisting of —NH₂, —NH—NH₂, —NH—NH—R³, —NH—R⁴, —NR⁵R⁶, —OR⁷ or —R⁸, where R³, R⁴, R⁵, R⁶, R⁷ and R⁸ are independently selected from the group consisting of aliphatic, araliphatic and aromatic hydrocarbons, which may have substitution, and n is an integer from 1 to 8, preferably from 1 to 6. In a preferred embodiment, for n=1, R is —CH₃, —OCH₃, —C₂H₅, —OC₂H₅, —C₃H₇, —OC₃H₇, —C_{I}H_{2I+1},—O—C_{I}H_{2I+1}, —O—C_{I}H_{2I}OH, —O—(C₂H₄O)ₘH, —O—(C₃H₆O)ₘH, —O—(C₄H₈O)ₘH, —NHCH₃, —NH—C_{I}H_{2I+1}, —NH—(C₂H₄O)ₘ, —NH—(C₃H₆O)ₘH, —NH—C_{I}H_{2I}—OH, —NH—(C₂H₄O)ₘ—C₂H₄NH₂, —NH—(C₃H₆O)ₘ—C₃H₆NH₂, —NH—(C₄H₈O)ₘ—C₄H₈NH₂, —NH—NH—C_{I}H_{2I+1}, —NH—NH—C_{I}H_{2I}OH, —NH—NH—C_{I}H_{2I}NH₂, —NH—NH—(C₂H₄O)ₘH, —NH—NH—(C₂H₄O)ₘ—C₂H₄NH₂, —NH—NH—(C₃H₆O)ₘH, —NH—NH—(C₃H₆O)ₘ—C₃H₆NH₂, —NH₂, and particularly preferably —NH—NH₂. I is an integer from 1 to 20, preferably from 1 to 10 and m is an integer from 1 to 50, preferably from 1 to 25.

For n=from 2 to 8, preferably n =from 2 to 6, and particularly preferably n=2, the compound (d) preferably corresponds to the general formula 2:

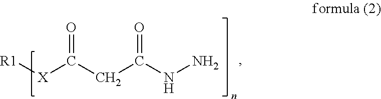

where X is O, S, NH—NH, or N—R², where R² is selected from the group consisting of hydrogen, aliphatic, araliphatic and aromatic hydrocarbons, which can have substitution, and is preferably hydrogen. R1 is a hydrocarbon moiety, which can have substitution, and R1 is preferably a polyether moiety, preferably based on ethylene oxide or propylene oxide, or is a polyester moiety, respectively with the functionality n, for example a polyether moiety or polyester moiety which corresponds to one of the polymeric compounds (b) having groups reactive toward isocyanate.

In a particularly preferred embodiment, the compound of the general formula 2 is obtained by esterification of a polyhydric alcohol, for example a glycol, for example ethylene glycol or propylene glycol, of an oligomeric polyhydric alcohol, for example diethylene glycol, triethylene glycol, dipropylene glycol or triethylene glycol, or of a polymeric alkylene oxide, of higher-functionality alcohols, for example trimethylolpropane, gylcerol, neopentyl glycol, 2-methyl-1,3-propanediol, 3-methyl-1,5-pentanediol, 1,4-butanediol, 1,6-hexanediol, pentaerythritol, sorbitol, or sucrose, with a compound of the formula 3:

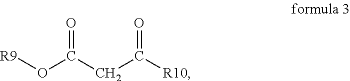

where R⁹ is a hydrogen atom or an alkyl moiety, preferably a methyl, ethyl, or propyl moiety, and R¹⁰ is —OR⁹, OH or —NH—NH₂. If R¹⁰ is OH or —OR⁹, the moiety of the formula 1 is obtained by subsequent reaction with H₂N—NH_{2.}

In a very particularly preferred embodiment, malonic dihydrazide is used as compound (d). This corresponds to the chemical formula:

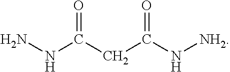

For the purposes of the present invention, quantities preferably used of the compound (d) of the general formula R(—S)ₙ, based on the total weight of components (a) to (f), are from 0.01 to 5% by weight, particularly from 0.05 to 2% by weight, and in particular from 0.1 to 1% by weight. The compound (d) can be used here as pure substance or in the form of a solution or of a dispersion. Examples of solvents/dispersion media that can be used are chain extenders or crosslinking agents (f), polymeric compounds or compounds (b) having groups reactive toward isocyanates, polyisocyanates (a), and water. It is moreover also possible to use the isocyanates (a) as solvents or dispersion media in particular for compounds (d) which have no adverse effect on the shelf life of the isocyanates (a). It is particularly preferable that the compound (d) is used in the form of an aqueous solution.

If the intention is that the polyurethane of the invention take the form of polyurethane foam, reaction mixtures of the invention also comprise blowing agent (e). It is possible here to use any of the blowing agents known for the production of polyurethanes. These can comprise chemical and/or physical blowing agents. These blowing agents are described by way of example in “Kunststoffhandbuch [Plastics handbook], volume 7, Polyurethane [Polyurethanes]”, Carl Hanser Verlag, 3rd edition 1993, chapter 3.4.5. The term chemical blowing agent here means compounds which form gaseous products through reaction with isocyanate. Examples of these blowing agents are water and carboxylic acids. The term physical blowing agents means compounds which have been dissolved or emulsified in the starting materials for the polyurethane production reaction and evaporate under the conditions of formation of polyurethane. These are by way of example hydrocarbons, halogenated hydrocarbons, and other compounds, examples being perfluorinated alkanes such as perfluorohexane, chlorofluorocarbons, and ethers, esters, ketones, acetals, and/or liquid carbon dioxide. Any desired quantity of the blowing agent can be used here. The quantity used of the blowing agent is preferably such that the density of the resultant polyurethane foam is from 10 to 850 g/L, particularly from 20 to 800 g/L, and in particular from 25 to 500 g/L. It is particularly preferable to use blowing agents comprising water.

Chain extenders and crosslinking agents (f) used here can be compounds of molar mass less than 400 g/mol which have at least two groups reactive toward isocyanates, the term chain extenders being used here for molecules having two hydrogen atoms reactive toward isocyanate, and the term crosslinking agent being used here for molecules having more than two hydrogens reactive toward isocyanate. However, it is also possible here to omit the chain extenders or crosslinking agents. Addition of chain extenders, crosslinking agents, or else optionally a mixture thereof can, however, prove to be advantageous for modification of mechanical properties, e.g. hardness.

If the intention is to use chain extenders and/or crosslinking agent, quantities usually used of these, in each case based on the total weight of components (b) to (f), are from 0.5 to 60% by weight, preferably from 1 to 40% by weight and particularly preferably from 1.5 to 20% by weight.

If chain extenders and/or crosslinking agents (f) are used, use may be made of the chain extenders and/or crosslinking agents known in the production of polyurethanes. These are preferably low-molecular-weight compounds having functional groups reactive toward isocyanates, for example glycerol, trimethylolpropane, glycol, and diamines. Other possible low-molecular-weight chain extenders and/or crosslinking agents are mentioned by way of example in “Kunststoffhandbuch [Plastics handbook], volume 7, Polyurethane [Polyurethanes]”, Carl Hanser Verlag, 3rd edition 1993, chapter 3.2 and 3.3.2.

It is moreover possible to use auxiliaries and/or additives (g). It is possible here to use any of the auxiliaries and additives known for the production of polyurethanes. Mention may be made by way of example of surface-active substances, foam stabilizers, cell regulators, release agents, fillers, dyes, pigments, flame retardants, hydrolysis stabilizers, fungistatic substances, and bacteriostatic substances. These substances are known and are described by way of example in “Kunststoffhandbuch [Plastics handbook], volume 7, Polyurethane [Polyurethanes]”, Carl Hanser Verlag, 3rd edition 1993, chapter 3.4.4 and 3.4.6 to 3.4.11.

Quantities reacted of the polyisocyanates (a), the polyols (b), compounds (d) of the general formula R(—S)ₙ, where R, S and n are defined as stated above and of, if used, the blowing agents (e) and chain extenders and/or crosslinking agents (f) during the production of the polyurethane of the invention are generally such that the equivalence ratio of NCO groups of the polyisocyanates (a) to the entirety of the reactive hydrogen atoms of components (b), (c), (d) and, if used, (e) and (f) are from 0.75 to 1.5:1, preferably from 0.80 to 1.25:1. If the cellular plastics comprise at least some isocyanurate groups, the ratio of NCO groups of the polyisocyanates (a) to the entirety of the reactive hydrogen atoms of component (b), (c), (d) and, is used, (e) and (f) is usually from 1.5 to 20:1, preferably from 1.5 to 8:1. A ratio of 1:1 here corresponds to an isocyanate index of 100.

The specific starting materials (a) to (g) for the production of polyurethanes of the invention respectively differ only slightly, quantitatively and qualitatively, when the intention is to produce, as polyurethane of the invention, a thermoplastic polyurethane, a flexible foam, a semirigid foam, a rigid foam or an integral foam. By way of example, production of compact polyurethanes uses no blowing agents, and thermoplastic polyurethane uses predominantly strictly difunctional starting materials. The elasticity and hardness of the polyurethane of the invention can moreover be varied by way of example by way of the functionality and the chain length of the relatively high-molecular-weight compound having at least two reactive hydrogen atoms. Such modifications are known to those skilled in the art.

The starting materials for the production of a compact polyurethane are described by way of example in EP 0989146 or EP 1460094, the starting materials for the production of a flexible foam are described by way of example in PCT/EP2005/010124 and EP 1529792, the starting materials for the production of a semirigid foam are described by way of example in “Kunststoffhandbuch [Plastics handbook], volume 7, Polyurethane [Polyurethanes]”, Carl Hanser Verlag, 3^{rd} edition 1993, chapter 5.4, the starting materials for the production of a rigid foam are described in PCT/EP2005/010955, and the starting materials for production of an integral foam are described in EP 364854, U.S. Pat. No. 5,506,275, or EP 897402. The compounds (d) are then in each case also added to the starting materials described in said documents.

The invention provides not only the process of the invention but also a polyurethane obtainable by a process of the invention. The polyurethanes of the invention are preferably used in enclosed spaces, for example as thermal insulation materials in residential buildings, for example insulation for pipes and refrigerators, in furniture construction, for example as decorative elements or as seat cushioning, as mattresses, and also in the space within vehicles, for example in automobile interiors, for example as steering wheels, dashboards, door cladding, carpet-backing foam, acoustic foams, for example roof linings, and also headrests or control knobs. There is a significant reduction here not only of formaldehyde but also of acetaldehyde emissions for polyurethanes of the invention in comparison with a reference product without additive, and also in comparison with prior-art aldehyde-reduction additives. Polyurethanes of the invention moreover emit only very small quantities of volatile organic compounds (VOC) in accordance with VDA 278 and VDA 277. Compounds (d), and in particular malonic dihydrazide, are heat-resistant. Even at reaction temperatures of up to 200° C. which can arise during the production of certain polyurethane foams, this compound therefore suffers no loss of activity.

Examples will be used below to illustrate the invention.

### Starting Materials

Polyol 1: glycerol-started polyether polyol based on ethylene oxide and propylene oxide with average OH number 27 mg KOH/g, average functionality 2.5 and 78% by weight propylene oxide content, based on the total weight of the polyether.

Polyol 2: glycerol-started polyether polyol based on ethylene oxide and propylene oxide with average OH number 35 mg KOH/g, average functionality 2.7 and 85% by weight propylene oxide content, based on the total weight of the polyether.

Polyol 3: glycerol-started polyether polyol based on ethylene oxide and propylene oxide with average OH number 42 mg KOH/g, average functionality 2.7 and 25% by weight propylene oxide content, based on the total weight of the polyether.

Polyol 4: glycerol-started polyether polyol based on ethylene oxide and propylene oxide with average OH number 28 mg KOH/g, average functionality 2.7 and 84% by weight propylene oxide content, based on the total weight of the polyether.

Polyol 5: Polyether polyol with OH number 250 mg KOH/g and average functionality 2.0 based on polyol 4 (35% by weight), propylene oxide (45% by weight) and dimethylaminopropylamine (20% by weight).

Polyol 6: Polyester polyol made from adipic acid, 1,4-butanediol, isopththalic acid and monoethylene glycol with average OH number 55 mg KOH/g.

TEOA: triethanolamine

Isopur SU-12021: black paste from ISL-Chemie

Emulsifier: hemiester of a maleic-acid-olefin copolymer

Jeffcat® ZF10: catalyst from Huntsman

### Additives

V1: adipic dihydrazide

V2: succinic dihydrazide

V3: carbonic dihydrazide

V4: acetic hydrazide

V5: trimethylolpropane triacetoacetate

A1: malonic dihydrazide

Iso 1: polymer diphenylmethane diisocyanate (PMDI) with 31.5% by weight NCO content and average functionality 2.7.

Iso 2: prepolymer made from methylenediphenyl diisocyanate, dipropylene glycol and polyether polyol with average OH number 250 mg KOH/g, functionality 2 and 83% by weight propylene oxide content, based on the total weight of the polyether, 23% by weight NCO content and average functionality 2.

Iso 3: mixture of methylene diphenyl diisocyanate and the corresponding carbodiimide with 29.5% by weight NCO content and average functionality 2.2.

The mixture A was produced by mixing of the following components:

50.0 parts by weight of polyol 1

34.3 parts by weight of polyol 2

2.0 parts by weight of polyol 3

3.0 parts by weight of polyol 5

6.0 parts by weight of polyol 6

0.5 part by weight of TEOA

0.5 part by weight of emulsifier

0.5 part by weight of Isopur SU-12021

2.9 parts by weight of water

0.3 part by weight of Jeffcat ZF10

from 0.3-1.2 parts by weight of compounds V1-V5 and A1 of table 1

The additives V1-V4 and A1 here were used in the form of aqueous solutions; V5 was used in the form of pure liquid substance. The total water content of the mixture A was set to 2.9 parts by weight.

The isocyanate component was produced by mixing of the following components:

30.0 parts by weight of Iso 1

35.0 parts by weight of Iso 2

35.0 parts by weight of Iso 3

The mixture A and the isocyanate component, and also the additives of table 1, were mixed with one another at an isocyanate index of 100 and charged to a closed mold in a manner that gave moldings with average density 120 g/L.

Formaldehyde and acetaldehyde were determined by a procedure based on ASTM D5116-06. The size of the chamber was 4.7 liters. The polyurethane samples used were pieces measuring 110 mm×100 mm×25 mm from the interior of the foam. The temperature in the test chamber during the test was 65° C., and the relative humidity was 50%. The air replacement rate was 3.0 liters per hour. The exhaust air stream with volatile aldehydes from the polyurethane was passed through a cartridge with 2,4-dinitrophenylhydrazine-coated silica for 120 minutes. The DNPH cartridge was then eluted with a mixture of acetonitrile and water. The concentration of formaldehyde and acetaldehyde in the eluate was determined by means of HPLC. The detection limit for formaldehyde emissions for this setup is ≤11 μg/m³, and for acetaldehyde emissions is ≤6 μg/m³.

Table 1: Formaldehyde values determined in the chamber for semirigid foams without addition of additives (reference), and also with addition of the respective additives V1-V5 and A1 at the stated concentrations, in each case stated in parts by weight of the abovementioned mixture A.

TABLE 1

| | Parts by | Formaldehyde | Acetaldehyde |
|---|---|---|---|
| | weight in A | (μg/m³) | (μg/m³) |
| Reference | — | 605 | 266 |
| V1 | 0.3% | 338 | 113 |
| V2 | 0.3% | 177 | 157 |
| V3 | 0.7% | 63 | 131 |
| V4 | 1.2% | 369 | 195 |
| V5 | 0.3% | 263 | 235 |
| A1 | 0.3% | <DL | 77 |

Table 1 shows that use of the additive Al (malonic dihydrazide) of the invention, even at low concentrations of 0.3 part by weight in the mixture A, reduces formaldehyde emissions to values below the detection limit of 11 μg/m³. The additive A1 moreover likewise substantially reduces acetaldehyde emissions.

Use of malonic dihydrazide moreover does not lead to any increase of volatile organic compounds VOC in accordance with VDA 277. The evidence for this is in table 2:

TABLE 2

| | Parts by | Total VOC |
|---|---|---|
| | weight in A | (ppm) |
| Reference | — | 10 |
| V5 | 0.3 | 72 |
| A1 | 0.3 | 10 |

1. A process for producing a polyurethane wherein
(a) polyisocyanate,
(b) polymeric compounds having groups reactive toward isocyanates,
(c) catalysts,
(d) compounds of a general formula R(—S)ₙ, and optionally
(e) blowing agents,
(f) chain extenders and/or crosslinking agents, and
(g) auxiliaries and/or additional substances
are mixed to give a reaction mixture, and the reaction mixture is reacted to completion to give the polyurethane,
where R is any desired moiety, n is any desired number from 1 to 8, and S is a moiety of formula 1:

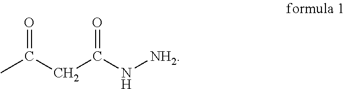

2. The process according to claim 1, wherein the compound R(—S)ₙ (d) corresponds to a general formula (2) 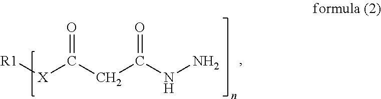
where X is O, S, NH—NH, or N—R², where R² is selected from the group consisting of hydrogen, aliphatic, araliphatic and aromatic hydrocarbons, which can have substitution, and R1 is a hydrocarbon moiety that can have substitution.

3. The process according to claim 1, wherein the compound of the general formula R(—S)ₙ, of component (d) is malonic dihydrazide.

4. The process according to claim 1, wherein a quantity of component (d) comprises, based on a total weight of components (a) to (f), from 0.01 to 5% by weight.

5. The process according to claim 1, wherein the polymeric compounds (b) having groups reactive toward isocyanates comprise polyetherols.

6. The process according to claim 1, wherein the catalysts (c) comprise incorporable amine catalysts.

7. The process according to claim 6, wherein the incorporable catalysts comprise compounds having, alongside the polymeric groups reactive toward isocyanates (b), one or more tertiary aliphatic amino groups.

8. The process according to claim 7, wherein at least one tertiary amino group of the incorporable catalyst bears two moieties mutually independently selected from methyl and ethyl moiety, and also bears a further organic moiety.

9. The process according to claim 1, wherein the polyurethane is a polyurethane foam with average density from 10 to 850 g/L.

10. The process according to claim 1, wherein the polyurethane is a compact polyurethane with average density more than 850 g/L.

11. The process according to claim 1, further comprising using the polyurethane as a mattress or part of an item of furniture.

12. A polyurethane which can be produced by a process according to claim 1.

13. A method of using polyurethanes according to claim 12, the method comprising using the polyurethanes in an enclosed space.

14. The method according to claim 13, wherein the enclosed space is a space within a means of conveying.
